(19) United States
(12) Patent Application Publication
(10) Pub. No.: US 2019/0279321 A1
(43) Pub. Date: Sep. 12, 2019

(54) PROOF OF PUBLIC IDEA DISCLOSURE USING BLOCKCHAIN

(71) Applicant: IdeaBlock LLC, Durham, NC (US)

(72) Inventors: Eli Michael Sheets, Raleigh, NC (US); Kitrick Brian Sheets, Sanford, NC (US)

(21) Appl. No.: 16/351,505

(22) Filed: Mar. 12, 2019

Related U.S. Application Data
(60) Provisional application No. 62/641,437, filed on Mar. 12, 2018.

(51) Int. Cl. G06Q 50/18; G06F 16/182; G06F 16/383; H04L 9/06

(52) U.S. Cl. CPC G06Q 50/184; G06F 16/1824; H04L 2209/38; H04L 9/0643; G06F 16/383

(57) ABSTRACT

Methods, apparatuses, and processor-executable instructions for proving public disclosure of an idea using blockchain technology are provided. For instance, in an aspect of the present disclosure, an example method performed by a controller for proving existence and public disclosure of an idea. In some examples, such an example method includes a controller entity receiving an idea from a source entity, proving existence of the idea by placing a representation of the idea on a first set of blockchains, and proving public availability of the idea at one or more instances by placing a representation of a state of a database of publicly served ideas on a second set of blockchains.

### CROSS-REFERENCE TO RELATED APPLICATIONS

The present application claims priority to U.S. Provisional Patent Application No. 62/641,437, entitled “Proof of Public Idea Disclosure Using Blockchain,” filed with the U.S.P.T.O. on Mar. 12, 2018, the entirety of which is incorporated by reference herein in its entirety.

### TECHNICAL FIELD

The application relates generally to blockchain technology, and particularly to techniques for proving public disclosure of an idea using one or more blockchains.

### BACKGROUND

In most legal jurisdictions throughout the world, a patent-issuing authority is obligated to reject patent claims where the subject matter defined in the claims has been previously disclosed publicly. Traditionally, such public disclosure was established via printed publications (e.g., books, magazines, government-published materials (including patents and patent application publications), and other common publication means) that are made generally available to members of the public, such as at a public library or government facility. With the advent of the Internet and other avenues for electronic publication (e.g., compact discs, voice recorders, etc.), however, definitions of what constitutes a public disclosure have been tested—and are currently still far from concrete.

Take, for instance, an Internet blog that is hosted via a cloud-based server, the content of which is generated and managed by an Inventor Anna. At any given point in time, Inventor Anna can add content to the blog, and this content could include the description of an idea or invention that Anna has recently conjured up in her mind or brought to life in her garage. Just as Anna could add content to the blog, however, Anna could remove content from the blog, and just as easily, could limit the availability of the contents of her blog to a certain limited subset of the public, or to nobody at all. Therefore, unlike a typical periodical made available at a public library, Anna has complete control over what subject matter related to the idea is made available to the public, as well as the extent to which the subject matter is made public, at any given time.

Given this temporal malleability inherent to Internet publications, the veracity of subject matter taken from such Internet sources for purposes of precluding patent rights to another entity is relatively limited when compared to traditional printed publications. This fact has been recognized by courts throughout the world, who have been reluctant to reject patent claims in applications filed after the alleged Internet publication of anticipatory subject matter. This can potentially leave some inventors (and/or businesses) in a precarious legal position when another entity subsequently obtains patent protection over the idea that was previously described in an Internet publication. Specifically, the inventor or business could potentially be the bona fide first inventor to conceive of and describe the idea, but because the description was only available via a traditional Internet web server, this disclosure could fail to defend the inventor or business against another entity that subsequently obtains patent rights over the idea or invention. Hearkening back to the example of Inventor Anna's blog, should Anna lack the knowledge or monetary resources to apply for a patent on an idea herself at or around the time the idea was placed on her blog, if Business BigBox subsequently obtains a patent that includes claims covering her idea or invention, Anna could be rendered defenseless in an infringement suit should she practice the idea or invention.

Accordingly, there is a need in the art for methods and systems that allow inventors, businesses, and other idea- and invention-creators to prove (a) that they conceived of a particular idea and (b) that a description of the idea was publicly available. Furthermore, given the rising costs of obtaining patent rights in many jurisdictions worldwide, there is a need in the art for such methods and systems that could provide such proof at a manageable cost to inventors and businesses whose ideas would otherwise go completely unprotected against those with the means to pursue patent protection.

### SUMMARY

Methods, apparatuses, and processor-executable instructions for proving public disclosure of an idea using blockchain technology are provided by the present disclosure. For instance, in an aspect of the present disclosure, an example method performed by a controller for proving existence and public disclosure of an idea. In some examples, such an example method includes a controller entity receiving an idea from a source entity, proving existence of the idea by placing a representation of the idea on a first set of blockchains, and proving public availability of the idea at one or more instances by placing a representation of a state of a database of publicly served ideas on a second set of blockchains.

In some examples, the representation of the idea and/or the representation of the state of the database of publicly served ideas comprises a hash, such as, but not limited to a SHA-256 hash. In some example embodiments described herein, the first set of blockchains and the second set of blockchains comprise the same set of blockchains, while in some others the first set of blockchains and the second set of blockchains have at least one blockchain in common and at least one blockchain that is not included in the other set of blockchains, while in yet others the first and second sets of blockchains are mutually exclusive.

In some examples, the feature of proving existence of the idea by placing the representation of the idea on a first set of blockchains can additionally or alternatively include obtaining one or more files describing the idea, processing the one or more files to obtain an archive file comprising the one or more files describing the idea, calculating a hash of the archive file as the representation of the idea, and sending the hash via a transaction on the first set of blockchains to place the hash on the first set of blockchains.

In some embodiments, proving public availability of the idea at one or more instances can include obtaining a result of a query to each of one or more network address endpoints associated with each of one or more of the publicly served ideas in the database at each of the one or more instances. In some examples, this can also include constructing a logical object for every instance of the one or more instances, the logical object comprising each result of each query for each of the one or more network address endpoints. Optionally, in some example embodiments, the representation of the state of the database of publicly served ideas can be a hash of the logical object.

Furthermore, the first set of blockchains and/or the second set of blockchains can include comprise one or more of the group of blockchains comprising: the Bitcoin blockchain, the Litecoin blockchain, the Ethereum blockchain, the Lightning network blockchain, one or more private blockchains, one or more blockchain-based databases, and/or any other database comprising immutable data.

In addition to the example methods provided above, the present disclosure also envisions associated devices, including processors, servers, computers, and the like for executing aspects of the methods introduced above and further described below in reference to the accompanying figures. The disclosure also provides example computer- and processor-executable instructions that can cause such devices to perform the aspects of the present disclosure.

These example aspects are meant to be illustrative of some embodiments envisioned under the scope of the present disclosure and the claims below and are not meant to be limiting. These embodiments, and certain variants thereof, have been described in sufficient detail to enable those skilled in the art to practice the invention.

### BRIEF DESCRIPTION OF THE FIGURES

FIG. 1 illustrates an example system for proving existence and public disclosure of an idea corresponding to example embodiments of the present disclosure.

FIG. 2 illustrates an example method performed according to one or more embodiments of the present disclosure.

FIG. 3 illustrates details of an example architecture and overall functionality of an embodiment of a system according to one or more embodiments of the present disclosure.

FIG. 4 illustrates an example method according to one or more embodiments of the present disclosure.

FIG. 5 illustrates details of an example computing device and clinical trial monitoring entity according to one or more embodiments.

### DETAILED DESCRIPTION

The present disclosure describes example techniques for leveraging blockchain technology to prove that an idea existed at a particular time and that the idea was publicly available thereafter, as well as systems and related devices for realizing these techniques. In particular, the present disclosure presents a system that can perform one or more of the following aspects: (a) obtain one or more documents containing a description of an idea from an source entity (e.g., an inventor and/or business), (b) place verification of the existence of the one or more documents on a blockchain (e.g., via one or more hashes of the one or more documents and/or a hash of some concatenation of multiple documents), (c) store the one or more documents (and/or their concatenation) on a private blockchain and/or another database, (d) provide public access to the one or more descriptive documents by serving the contents of the private blockchain and/or another database via a free and persistent web server, (e) periodically generate a file or files identifying and/or verifying the availability of all previously uploaded ideas (e.g., via hashing) through the public database (i.e., a “snapshot” of a “state” of the public database), and (f) place the generated file(s) indicating each periodic snapshot of the state (and/or some other identifier of the periodic state snapshot) and/or a hash thereof on one or more of a public blockchain, private blockchain, or other database. Accordingly, should it become necessary at a later time, the source entity can provide proof through recognized techniques of mathematical verification (e.g., hash and/or signature verification) that they conceived of an idea or invention and that a description of the idea or invention was continuously available to the public thereafter.

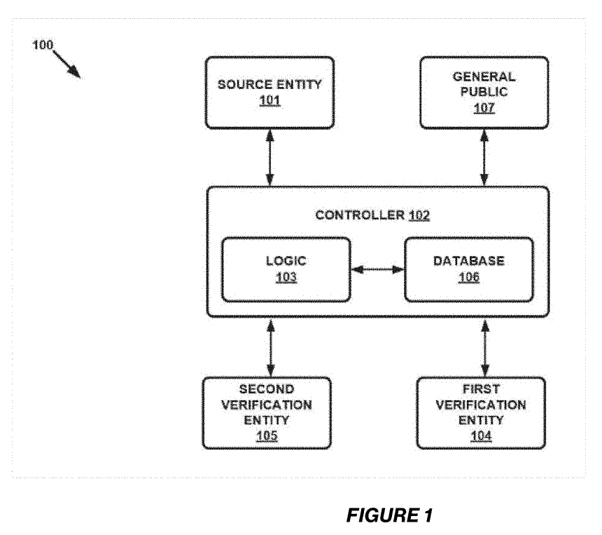

FIG. 1 illustrates an example system 10 for implementing the techniques introduced above. As shown, the system includes a controller 102 that can include one or more processors and/or memory for executing one or more functions/aspects of the invention described herein. This controller 102 can include logic 103 that controls and manages the performance of these aspects, as well as a database 106, which, as will be explained further below, is configured to serve, to the public, a set of user-provided source files describing an idea. The controller 102 can be housed, for instance, on a local or cloud-based server or one or more servers, and may include disparate processors/CPUs/VMs/instances which may or may not function in unison to realize the features of the invention described herein.

In an aspect, the controller 102 can communicate with a source entity 101 (a user or user computer), from which the controller 102 can obtain one or more source files describing an idea or invention that the user or other controller of the source entity 101 wishes to upload to the system 100 for protection. The source files can be of any format or file standard known in the art, such as, but not limited to, image files (PNG, JPEG, GIF, TIFF), video files (MOV, MP4 (MPEG4), AVI, WMV, FLV, 3GP, MPEGPS, WebM, GIF), audio files (MP3, OGG, FLAG, WAV, WMA, AMR, M4A, AIFF, AIF, AAC, MP2, GSM, 3GA, AU AND RA, etc.) document files (PDF, DOC, DOCX, XLS, XLSX, PPT, PPTX, TXT, etc.), compressed versions of one or more files (tarball, ZIP, etc.). In any case, each of the source files can be any file type that, when rendered or otherwise presented to a member of the public, substantially discloses contents of an idea to the member of the public. The file can be uploaded via HTTP, jQuery, websockets (e.g. socket.io) a wrapper package that utilizes these standard communication media, directly or indirectly (e.g., via middleware, relays, 3^{rd} party servers/services/memory) etc. The controller 102 can also record and store a time instant at which the source file(s) were uploaded.

Once the source file(s) are received, the controller 102 can perform several subsequent functions to realize the desired ends of proving that the idea embodied in the file(s) existed at the time of uploading and that it was available to the public from that time forward. First, the logic 103 can be configured to generate a single file of a known format out of the one or more uploaded source files, which will be referred to herein as an “Idea File” or the like. This Idea File can constitute a comprehensive representation of every source file associated with a particular uploaded set of source files (i.e. a single idea for every single Idea File, but potentially more than one source file). For instance, this could comprise an archive consisting of all of the source files (SHAR, CPIO, ZIP, RAR, TAR, 7Z, JAR, Cabinet, ARJ, XAR, WIM, or the like), a disk image file such as a Dockerfile, a PDF representation of the concatenation of all document-type files, or the like. Any of these file types or a file type not specifically listed but known in the art could be utilized as the Idea File type, so long as it can be replicated across datastores, deconstructed or unzipped, and unchangeable or resistant to changes in raw file data and/or metadata across time, operating environment or framework, and storage location (i.e. linear and time- and space-invariant).

These properties of the chosen Idea File type are relevant to an additional aspect of the controller 102: creating a hash of the Idea File that will be placed on the blockchain and will serve as a timestamp for the existence of the idea. Unpacking that functionality, the logic 103 of the controller 102 can be configured to generate a hash of the Idea File using any known hash function (or any known document validation mechanism, generally), which can include, but is not limited to, one or more of the following: a cryptographic hash function (MD5, SHA-1, SHA-256 and SHA-512), a non-cryptographic hash function, a checksum (letcher, Adler, CRC, etc.), signature, or the like.

Regardless of the particular hash function utilized to generate a hash based on the Idea File, the resulting hash is then sent to a first verification entity 104, which can store the hash and return an address where the hash is located at the first verification entity 104. In an aspect, the first verification entity 104 can be a blockchain, such as, but not limited to, a robust and widely used public blockchain. One property of such blockchains is immutability, meaning that once a block is sufficiently verified by a mining pool associated with the blockchain, the contents of the block cannot change thereafter. As this cornerstone property of blockchains has been repeatedly proven mathematically, it can reasonably be taken as a given that the idea existed at the time the hash is placed on the blockchain based on the astronomical size of the number set associated with the cryptographic functions underlying the blockchain. Therefore, proof of existence of the idea can be proven by storing a hash of the Idea File on a public blockchain (first verification entity 104) at the time it is created and the source files/associated information placed in database 106, and then subsequently can be verified by again generating the hash of the Idea File and comparing it to the hash on the blockchain when necessary.

As introduced above, the Idea File can then be stored, along with the source files, and metadata (e.g. user or business specific data, comments input by the user, file data, etc.) in the database 106 and potentially elsewhere, such as in a replicated, robust data store to ensure that the files are maintained. In some examples, the source files and/or Idea File are stored on a private blockchain mined by a private network of nodes. This will be discussed further below.

The Idea File and source files for all previously uploaded ideas, along with potentially other characteristic data about the users, businesses, upload time, etc. that are stored on the database 106 can be made publicly available by the controller 102 via a public-facing website hosted on a webserver by controller 102. Accordingly, because the uploaded source files comprising an updated idea from a user is placed in the database 106, the idea is also made publicly available, and thus the second requirement for prior art in at least some patent law jurisdictions is fulfilled. However, because the webserver serving the database 106 to the general public 107 can be essentially a simple webserver, it may not be enough to simply serve the source files for all uploaded ideas, as it is nothing more than the current paradigm where content on a webserver could be changed by an administrator at any given time. Accordingly, aspects of the present disclosure use blockchain technology to solve this problem by proving that, at a given point in time, the source files, Idea Files, and/or metadata uploaded before that time were available to the general public 107.

In particular, the present disclosure can, at certain intervals or based on certain trigger events, take inventory of the contents of the database 106 being served to the public 107. Controller 102 can store some representation of the files, or the files themselves, as a “snapshot” of what is being served to the general public 107 at that point in time. As will be explained below, the “snapshot” of the database 106 itself, or a representation thereof (such as a hash of the files), can be stored on a second verification entity 105, which can be a private blockchain in some examples. In other examples, for instance, where the snapshot of the database 106 is represented as a hash created from a single file (e.g., an archive file, etc) made up of the files being served at a certain time, the hash could be placed on the first verification entity 104 in addition to the hash of the Idea File.

Under this paradigm, both existence of the idea and public availability of the idea can be proven by using the techniques described herein. Accordingly, by uploading a description of an idea (via one or more source files) the user can protect him or herself (of the business entity if the user is a business) from any patents covering the described idea being subsequently filed and issued to a third party. If such a patent is issued to such a third party, the user can either attempt to have the patent invalidated preemptively (i.e. before enforcement against the user, for instance, via administrative means like the post-grant procedures defined in the America Invents Act in the United States of America or in other similar procedures in other jurisdictions) or as a defense to infringement should the third party sue the user who uploaded the idea that was later patented by the third party.

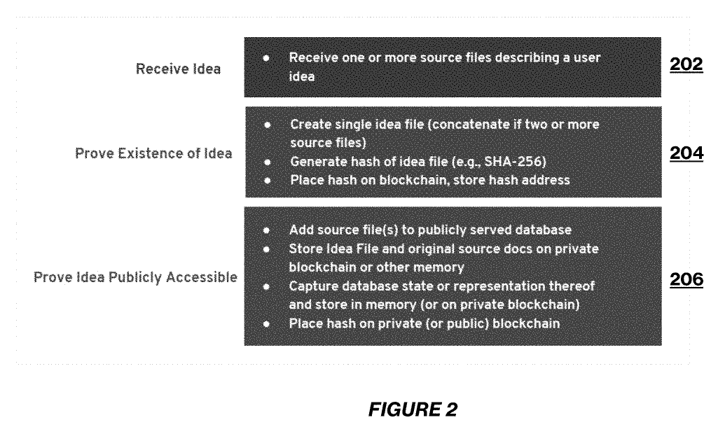

FIG. 2 presents example aspects of a method performed by system 100 according to certain embodiments. As introduced above, the controller 102 (e.g., a server, processor, application instance) can receive an idea in the form of one or more source files describing a user idea. Again, these files can comprise files of different type or according to different specifications so long as they can each be rendered such that the idea is fully described and available for consumption if presented to a member of the general public.

The method can also include proving the existence of the uploaded idea by leveraging the immutability property of a blockchain. Providing this proof can include forming a single Idea File out of the separate source files uploaded to the system 100, the Idea File being, for instance, an archive file (ZIP, tarball, etc.), disk image file (Dockerfile, etc), or other file type that is robust to change in terms of time, operating environment, and location. This robustness assists in carrying out aspects of the present disclosure because the Idea File can be input into a hash function to generate a hash that will be placed on a public (or private) blockchain. If even a single bit of the Idea File changes, the hash output by the same hash function could render the resulting hash completely different than the initially generated hash. As such, should even a single bit in the Idea File change between the time the initial hash is generated from the Idea File and the time at which verification is needed (i.e., to prove to a judge, jury, ALJ, examiner, opposing counsel, that the patent was anticipated or obvious), the hash stored on the blockchain will be different from the later-generated hash, and therefore verification will fail. If the Idea File is properly stored in a robust database system (e.g., that is replicated throughout the globe and potentially even placed on a private blockchain in the system 100), however, the hashes should match and therefore prove the existence of the Idea File and its component source files at the time of uploading (given the timestamp on the blockchain upon which the hash was stored).

Finally, the method can include proving that the idea was publicly accessible, a requirement of any prior art that is to be proffered as anticipatory in most jurisdictions. To meet this goal, in example embodiments, the controller 102 can be configured to add the one or more source files in a publicly served database 106 that can be explored, searched, and queried by the general public 107 in perpetuity from the moment of its writing to the database 106. In addition, the system 100 can be configured to store the Idea File comprising the individual source files in the database, external memory (e.g., a bulk data store in the cloud, for example), and/or on a private blockchain (private meaning not on a generally accessible blockchain that is well-known, such as the Bitcoin blockchain, the Ethereum blockchain, etc.).

In addition, the method can include the controller 102 obtaining, periodically (e.g. every 1, 4, 12, 24 hours, etc.) or based on a triggering event (e.g., a new idea source file upload by a user, etc), a snapshot of the contents of database 106 that are presently accessible by the general public 107 (also referred to herein as “state” of the database) or a representation of the contents presently served. This can be accomplished, for instance by any of (1) creating an archive file or multiple archive files that contain the contents of the database 106, (2) identifying the changes in the content served from the database 106 since a last time the database state was generated, or (3) using a list of document identifiers or signatures for the documents or files served from the database 106. This state or snapshot, whether in the form of an archive file or some smaller file, data structure, or string can then be placed in the the public or private blockchain. Subsequently, when a user or business seeks to verify to a judge, opposing counsel, jury, etc., the times at which his or her uploaded idea was available to the public, they can use timestamps for when the file or string representing the database state was stored on the blockchain, or a hash thereof, to compare to a later-generated contents list or hash of these stored files. Through this technique, one can regressively calculate a proven timeline for when each uploaded file was available and served to the public via the database 106, therefore providing proof with mathematical certainty that an Idea File existed at a point in time and that the contents of the database were being served to the public over a particular time. Therefore, aspects of the present embodiments can fulfill the two requirements for establishing anticipation of the patent, giving the users of system 100 a quasi-patent right to protect them against enforcement of a subsequently granted patent to their own idea against them.

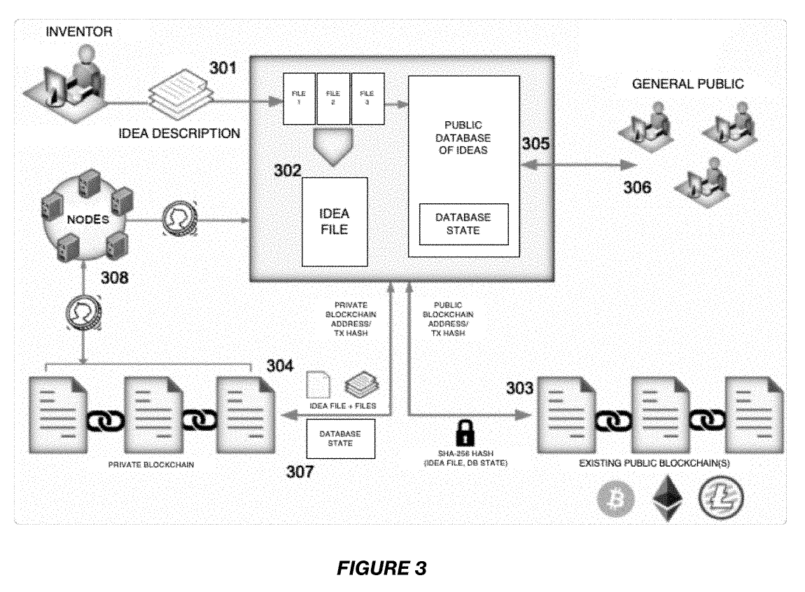

FIG. 3 presents a system-level diagram of an example architecture and overall functionality of system 100 and controller 102, among other devices. In particular, FIG. 3 provides step-by-step regarding example aspects of the system that can be implemented to prove a user's idea existed at the time it was uploaded and that it was available to the general public with the help of the system. At 301, an inventor (i.e. user) uploads a description of one or more ideas via one or more files and potentially additional data input via a form in a web interface for example. These files and data (which can be included in an additional file itself) are uploaded to the controller (the shaded box). At 302, the controller processes the uploaded files describing the idea and, in some example embodiments, bundles the files and the data into an archive file (e.g. a .zip, .7z, .tar, or the like) that may be referred to herein as the “Idea File,” and a cryptographic hash (SHA-256, etc.) is generated for this Idea File. In an aspect, at 303, the generated hash is written to a robust, trustworthy public blockchain (e.g. Bitcoin, Litecoin, Ethereum, and/or the like) and the location of the hash on the blockchain (or blockchains) is returned and stored locally or in a traditional or immutable database associated with the controller. This location can come in the form of a transaction number, transaction hash, block height, block number, or any other direct or relative location indicator available for any particular implemented blockchain. In addition, at 304, in some instances, the uploaded files or representations thereof, as well as that of the concatenated Idea File (if applicable), can be additionally stored on a private (or semi-private) blockchain.

Furthermore, in an aspect, at 305, the controller can store uploaded files and select metadata or other information in a database associated with the controller (can be a locally stored database or a cloud-based database in some instances). In some embodiments, at 306 the contents of this database and any associated object storage of the files and/or Idea File are served to the general public with minimal downtime to ensure that sufficient idea information is publicly accessible. In other embodiments, some information may be kept private such as user identity.

Other times, the files may be stored in the database but not served to the public. In these embodiments, the system can provide proof via the action at 301, 302, and 303, that a particular user possessed the idea at a certain time (via the blockchain timestamp). This can be utilized, for instance, for users who may wish to prove prior conception or prior commercial use of an idea so as to qualify for a prior use exception in a future infringement suit. With the timestamp and a comparison of the associated idea hashes to files describing the prior commercial use, the user can unassailably demonstrate such prior commercial use.

In a further aspect, at 307, to prove availability of idea information at any given time, proof of public availability of the served database data can be achieved at certain intervals or time instances. This can be accomplished in several example ways. For example, this can be achieved by the controller or another entity retrieving idea-specific web endpoints repeatedly at the intervals or time instances and storing the response data and/or comparing the endpoint data or file hashes to known idea hashes, taking snapshots of the database state at the intervals or instances, utilizing trustless web service providers and/or oracle networks to provide smart-contract leveraged API data that is provable as true, are stored on the private blockchain.

In a particular example implementation at 307, the system can prove public availability of the idea at one or more instances by obtaining a result of a query to each of one or more network address endpoints associated with each of one or more of the publicly served ideas in the database at each of the one or more instances (or intervals). For instance, the controller or another 3^{rd}-party device or service can receive an instruction to crawl the available idea web endpoints as if the controller or 3^{rd}-party device were a member of the general public. The response from the controller-based server for service these ideas and idea files can be stored, checked against file hashes and previously known content to determine if the idea data is properly aligned with the uploaded files and information for that idea uploaded by the user.

At this point, the controller or the 3^{rd}-party device can, in some instances, construct a logical object for every query instance of the one or more instances, the logical object comprising each result of each query for each of the one or more network address endpoints. In other words, the object can capture the query return information to indicate that the endpoint returns information and not an error, but also if any anchor tag file endpoints point to files that have the same hash as the previously uploaded files, proving that these same files are available at the queried endpoint (thereby proving public availability and creating undeniable prior art). These query returns or representations thereof (e.g. hashes) can effectively comprise a snapshot or temporal state of the database of publicly served ideas in a single object. In some instances, unlike 307, this logical object may not be stored in a private blockchain, but instead in a public blockchain and/or the database itself for later proving a calendar or history of public availability of each idea every week/day/hour/minute or whatever other granularity necessary to prove public availability of the idea at its unique endpoint. To add a degree of trustlessness, the interval and/or time instance for a query can be randomized in time to avoid any possibility that the controller could serve the idea files or idea information only at a time that it might be queried—thereby avoiding accusations that the controller is “cooking the books” on the results from its own server during the queries.

In a further optional aspect, at 308 platform-specific coin can be issued to incentivize mining and general participation. Coin can be used to propose funding of certain uploaded ideas (e.g., platform-specific crowd-based funding/capital market), to pay for services, etc.

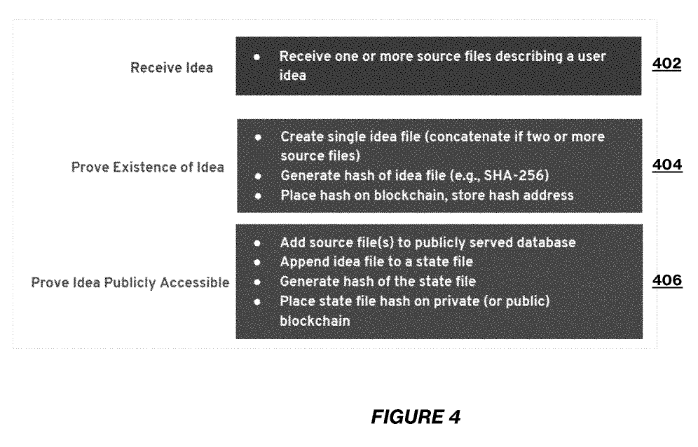

FIG. 4 illustrates a further example method performed by the system 100 and/or controller 102. As in the controller of FIG. 2, the system 100 can receive a description of an idea via one or more source files, and can again prove the existence of the idea by placing a generated hash of the Idea File associated with the uploaded source files onto a blockchain and storing a blockchain address of the stored hash location that is returned when the hash is written to the blockchain and/or the block is validated by the blockchain network (i.e. mined).

The additional aspect of FIG. 4 that differs from the controller of FIG. 2 or that of the incremental query-based public availability proof described with respect to 307 at servable database state (e.g., periodically or upon detection of a triggering event such as a new idea being uploaded or stored). Specifically, as shown in FIG. 4, after adding the source files to the publicly served database 106, the system 100 and/or controller 102 can generate a “State File” that can essentially comprise a concatenation of all idea files in some known order (e.g. from upload time to alphabetically by last name of inventor, and any other ordering rule in-between). This order of Idea Files is kept securely and can be dynamic in that its contents change (the served contents grows, for example) with every upload. The controller 102 can, when scheduled or when a trigger event occurs, query the database and can append any new uploaded files to the Idea File in a particular order (e.g., such as, but not limited to, temporal order of upload). Then, once this State File is assembled with all Idea Files/served files (or representations thereof) included in the State File, the controller 102 can generate a hash of the State File, which is, by definition, unique for all files that differ by even a single bit value. So unique, in fact, that it holds no matter if the file is only a few files (such as the Idea File) or much more content bundled into a single archive file or the like. In other words, the system 100 can place a hash of the State File in a private blockchain (or even the public blockchain used for the Idea File hash). This way, when validation is needed most likely years down the line, the system can identify which files for that particular idea upload must be bundled together or concatenated to generate the hash again, but this time in order to compare it to the hash generated from those same documents when it was uploaded.

So, returning to FIG. 4, to prove the idea description was publicly accessible, rather than storing source files and Idea Files themselves on a blockchain (or database, etc) as well as bulky files explicitly indicating a state of the database, the system can instead maintain a log-type file that fetches previously generated and ordered Idea Files, puts the Idea Files into a particular order (e.g., upload date and time) to form a State File, generates a hash of this State File, and then stores that hash on a public or private blockchain.

When it comes time to validate that an idea existed and whether it was publicly accessible ever since it was uploaded and hashed to the blockchain, the system can query the ordered list of Idea Files, build the State File from these Idea Files placed in the correct order, and generate the hash again. This subsequently generated hash can then be compared to the previous hash. If the hashes match, then it proves that the files for that particular idea were indeed available to the public at this particular interval in time. To prove that the source files/idea were available continuously since uploading, this technique for proof of database contents can be repeated across several time periods to confirm the substantially continuous availability of the relevant Idea File and/or associated source files to the general public, thereby proving the second prong of establishing confirmed prior art under patent law in most jurisdictions.

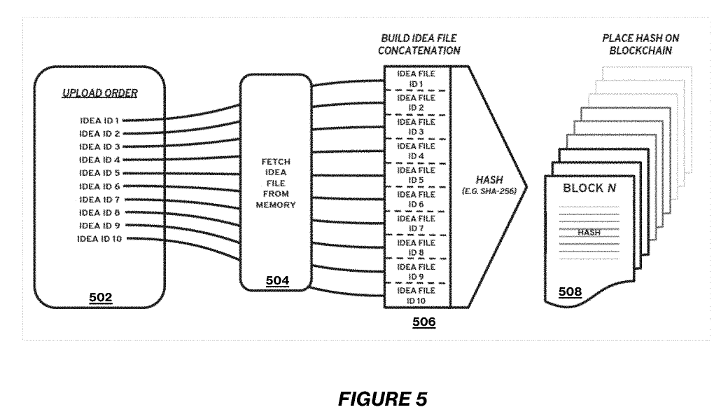

This example technique is further illustrated in FIG. 5, where a concatenation of Idea Files (otherwise referred to herein as the State File) is built, then hashed and placed on a blockchain to ensure immutability for proving the set of Idea Files that were served by the database at the time this Idea File concatenation (State File) was generated. As shown, an ordered list of Idea IDs (given to a particular uploaded idea or source file batch at upload time) is queried by the controller 102, and based on the Idea IDs, the controller 102 fetches each Idea File associated with the Idea ID from the database, external memory, and/or private blockchain on which it is stored. Once all of the ordered Idea Files are fetched and concatenated in order to form a State File, the controller 102 can generate a hash of the State File (e.g. using SHA-256 or the like) and can place the hash of the State File on the blockchain (public or private). At that point, once the block containing the hash is confirmed/validated by the mining pool, an address is returned that can be used to fetch the hash if validation of the idea and its source files or Idea File are ever needed.

In an aspect, the controller 102 and/or one or more other devices are configured, e.g., via functional components, means, or units (including but not limited to those components shown in the Figures), to implement processing to perform the aspects described above in reference to, for instance, FIGS. 1-5.

In at least some embodiments, the controller 102 comprises one or more processing circuits configured to implement processing of the methods and techniques outlined herein, such as by implementing functional means or units above. In one embodiment, for example, the processing circuit(s) implements functional means or units as respective circuits. The circuits in this regard may comprise circuits dedicated to performing certain functional processing and/or one or more microprocessors in conjunction with memory (internal or external). In embodiments that employ memory, which may comprise one or several types of memory such as read-only memory (ROM), random-access memory, cache memory, flash memory devices, optical storage devices, etc., the memory stores program code that, when executed by the one or more for carrying out one or more microprocessors, carries out the techniques described herein.

In one or more embodiments, the controller 102 also comprises one or more communication interfaces and circuitry. The one or more communication interfaces include various components (e.g., antennas) for sending and receiving data and control signals. More particularly, the interface(s) include a transmitter that is configured to use known signal processing techniques, typically according to one or more standards, and is configured to condition a signal for transmission (e.g., via a wired transmission line or over the air via one or more antennas). Similarly, the interface(s) include a receiver that is configured to convert signals received (e.g., via a modem or the antenna(s)) into digital samples for processing by the one or more processing circuits. The transmitter and/or receiver may also include one or more antennas or modems. By utilizing the communication interface(s) and/or antenna(s), the computing device is able to communicate with other devices to transmit feedback and receive data as well as manage the clinical trial processes as described above.

Processor-executable instructions (i.e. computer programs) are also envisioned by the present disclosure, where the processor-executable instructions comprises instructions which, when executed on at least one processor of the controller 102 cause it to carry out any of the respective processing described above. Furthermore, the processing or functionality may be considered as being performed by a single instance or a processor or other device or may be divided across a plurality of instances/devices of controller 102 that may be present in a given system 100 such that together the device instances perform all disclosed functionality. Example embodiments further include a computer program. A computer program in this regard may comprise one or more code modules and/or instructions corresponding to the means or units described above and can be executed thereon.

The present embodiments may, of course, be carried out in other ways than those specifically set forth herein without departing from essential characteristics of the invention. The present embodiments are to be considered in all respects as illustrative and not restrictive, and all changes coming within the meaning and equivalency range of the appended example enumerated embodiments are intended to be embraced therein.

What is claimed is:

1. A method performed by a controller for proving existence and public disclosure of an idea, comprising:
receiving an idea from a source entity;
proving existence of the idea by placing a representation of the idea on a first set of blockchains; and
proving public availability of the idea at one or more instances by placing a representation of a state of a database of publicly served ideas on a second set of blockchains.

2. The method of claim 1, wherein the representation of the idea and/or the representation of the state of the database of publicly served ideas comprises a hash.

3. The method of claim 2, wherein the hash is a SHA-256 hash.

4. The method of claim 1, wherein the first set of blockchains and the second set of blockchains comprise the same set of blockchains.

5. The method of claim 1, wherein the first set of blockchains and the second set of blockchains have at least one blockchain in common and at least one blockchain that is not included in the other set of blockchains.

6. The method of claim 1, wherein proving existence of the idea by placing the representation of the idea on a first set of blockchains comprises:
obtaining one or more files describing the idea;
processing the one or more files to obtain an archive file comprising the one or more files describing the idea;
calculating a hash of the archive file as the representation of the idea; and
sending the hash via a transaction on the first set of blockchains to place the hash on the first set of blockchains.

7. The method of claim 1, wherein proving public availability of the idea at one or more instances comprises obtaining a result of a query to each of one or more network address endpoints associated with each of one or more of the publicly served ideas in the database at each of the one or more instances.

8. The method of claim 7, further comprising constructing a logical object for every instance of the one or more instances, the logical object comprising each result of each query for each of the one or more network address endpoints.

9. The method of claim 8, wherein the representation of the state of the database of publicly served ideas comprises a hash of the logical object.

10. The method of claim 1, wherein the first set of blockchains and/or the second set of blockchains comprise one or more of the group of blockchains comprising: the Bitcoin blockchain, the Litecoin blockchain, the Ethereum blockchain, the Lightning network blockchain, one or more private blockchains, one or more blockchain-based databases, and/or any other database comprising immutable data.

11. A controller for proving the existence and public disclosure of an idea, the controller configured to:
receive an idea from a source entity;
prove existence of the idea by placing a representation of the idea on a first set of blockchains; and
prove public availability of the idea at one or more instances by placing a representation of a state of a database of publicly served ideas on a second set of blockchains.

12. The controller of claim 11, wherein the representation of the idea and/or the representation of the state of the database of publicly served ideas comprises a hash.

13. The controller of claim 12, wherein the hash is a SHA-256 hash.

14. The controller of claim 11, wherein the first set of blockchains and the second set of blockchains comprise the same set of blockchains.

15. The controller of claim 11, wherein the first set of blockchains and the second set of blockchains have at least one blockchain in common and at least one blockchain that is not included in the other set of blockchains.

16. The controller of claim 11, wherein being configured to prove existence of the idea by placing the representation of the idea on a first set of blockchains comprises being configured to:
obtain one or more files describing the idea;
process the one or more files to obtain an archive file comprising the one or more files describing the idea;
calculate a hash of the archive file as the representation of the idea; and
send the hash via a transaction on the first set of blockchains to place the hash on the first set of blockchains.

17. The controller of claim 11, wherein being configured to prove public availability of the idea at one or more instances comprises being configured to obtain a result of a query to each of one or more network address endpoints associated with each of one or more of the publicly served ideas in the database at each of the one or more instances.

18. The controller of claim 17, wherein the controller is configured to construct a logical object for every instance of the one or more instances, the logical object comprising each result of each query for each of the one or more network address endpoints.

19. The controller of claim 18, wherein the representation of the state of the database of publicly served ideas comprises a hash of the logical object.

20. A computer-readable medium storing processor-executable instructions, wherein the instructions, when executed by a processor, cause the processor to:
receive an idea from a source entity;
prove existence of the idea by placing a representation of the idea on a first set of blockchains; and
prove public availability of the idea at one or more instances by placing a representation of a state of a database of publicly served ideas on a second set of blockchains.
